(19) United States
(12) Patent Application Publication
(10) Pub. No.: US 2002/0107894 A1
(43) Pub. Date: Aug. 8, 2002

(54) Method and apparatus for selectively inserting formatting commands into web pages

(76) Inventors: Joseph H. Kent III, Burlingame, CA (US); Paul B. Mishkin, Sunnyvale, CA (US); Li Li, San Mateo, CA (US)

Correspondence Address: PARK, VAUGHAN & FLEMING LLP, 508 SECOND STREET, SUITE 201, DAVIS, CA, 95616, US

(21) Appl. No.: 09/729,728

(22) Filed: Dec. 4, 2000

(51) Int. Cl. G06F 17/24

(52) U.S. Cl. 707/517; 707/522

(57) ABSTRACT

One embodiment of the present invention provides a system that selectively inserts formatting commands into textual information to be displayed on a web page. This system starts by receiving textual information from a user to be displayed on the web page. Next, the system looks for specific formatting commands in the textual information, which indicate that additional formatting commands should not be inserted into the textual information. If none of the specific formatting commands are found in the textual information, the system inserts additional formatting commands into the textual information so that the textual information is displayed on the web page in substantially the same format as it was entered by the user.

### BACKGROUND

1. Field of the Invention

The present invention relates to the formatting of textual information for display on a computer system. More specifically, the present invention relates to a method and an apparatus that selectively inserts formatting commands into textual information to be displayed on a web page.

2. Related Art

As use of the Internet continues to increase at an exponential rate, users are continually adding content to web pages to be viewed through web sites. Web pages are commonly written in the Hypertext Markup Language (HTML), which allows a user to specify formatting commands for textual information, images and tables within web pages. Unfortunately, HTML relies on cryptic formatting commands, which cannot be easily used by people who are not trained as computer programmers. Hence, people who are not trained as programmers are often forced to hire expert web site designers to format information for display on web pages.

In order to alleviate this problem, a number of tools have been developed to convert the formatting information within a piece of text into corresponding HTML commands. For example, spaces and newlines that appear in text can be automatically converted into the corresponding HTML commands “&NBSP” and “<br>”. Tools of this type allow a novice user to easily display textual information on a web page.

However, in some cases an experienced user may want to be able to more precisely control the layout of a web page by explicitly inserting formatting commands into the textual information. In other cases, users may want to alter the appearance of textual information by inserting commands to make bold, italicize and underline characters, with having to worry about inserting formatting commands to specify the position of the textual information within a display.

What is needed is a method and an apparatus that selectively inserts formatting commands into textual information to be displayed on a web page, so that experienced users can explicitly insert their own formatting commands, while other less experienced users can have formatting commands inserted for them.

### SUMMARY

One embodiment of the present invention provides a system that selectively inserts formatting commands into textual information to be displayed on a web page. This system starts by receiving textual information from a user to be displayed on the web page. Next, the system looks for specific formatting commands in the textual information, which indicate that additional formatting commands should not be inserted into the textual information. If none of the specific formatting commands are found in the textual information, the system inserts additional formatting commands into the textual information so that the textual information is displayed on the web page in substantially the same format as it was entered by the user.

In one embodiment of the present invention, the specific formatting commands include commands that alter a location of the textual information within the web page.

In one embodiment of the present invention, the specific formatting commands include commands that will not work if additional formatting commands are added to the textual information.

In one embodiment of the present invention, the specific formatting commands adhere to the Hypertext Markup Language (HTML) standard.

In one embodiment of the present invention, the system additionally replaces HTML-unsafe characters with HTML-safe escape codes to avoid problems in displaying the textual information.

In one embodiment of the present invention, the specific formatting commands do not include commands that: make bold text, italicize text, underline text, and add a horizontal line.

In one embodiment of the present invention, the specific formatting commands include: line break, paragraph and table-related commands.

### BRIEF DESCRIPTION OF THE FIGURES

FIG. 1 illustrates a networked computer system in accordance with an embodiment of the present invention.

FIG. 2 is a flow chart illustrating the process of selectively inserting formatting commands into textual information in accordance with an embodiment of the present invention.

FIG. 3A illustrates an example of how specific textual information appears on a display in accordance with an embodiment of the present invention.

FIG. 3B illustrates another example of how specific textual information appears on a display in accordance with an embodiment of the present invention.

FIG. 3C illustrates yet another example of how specific textual information appears on a display in accordance with an embodiment of the present invention.

FIG. 3D illustrates an additional example of how specific textual information appears on a display in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

### Computer System

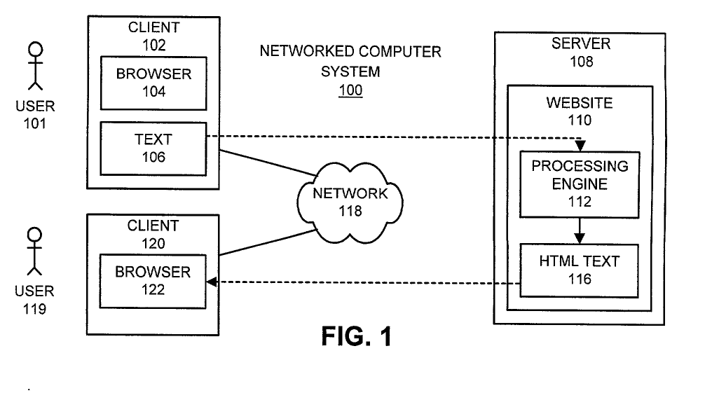

FIG. 1 illustrates a networked computer system 100 in accordance with an embodiment of the present invention. Networked computer system 100 includes clients 102 and 120, which are coupled to server 108 through network 110.

Network 110 can generally include any type of wire or wireless communication channel capable of coupling together computing nodes. This includes, but is not limited to, a local area network, a wide area network, or a combination of networks. In one embodiment of the present invention, network 110 includes the Internet.

Clients 102 and 120 and server 108 can generally include any type of computer system, including, but not limited to, a computer system based on a microprocessor, a mainframe computer, a digital signal processor, a portable computing device, a personal organizer, a device controller, and a computational engine within an appliance. Clients 102 and 120 are operated by users 101 and 119, respectively.

More specifically, clients 102 and 120 can include any node on network 110 including computational capability and including a mechanism for communicating across network 110. Clients 102 and 120 contain browsers 104 and 122, respectively. Browsers 104 and 122 can generally include any type of web browser capable of viewing a web site, such as the INTERNET EXPLORER™ browser distributed by the Microsoft Corporation of Redmond, Wash.

Server 108 can generally include any node on a computer network including a mechanism for servicing requests from a client for computational and/or data storage resources. Server 108 includes web site 110, which includes inter-linked pages of textual and graphical information that can be navigated through by users 101 and 119 through browsers 104 and 122, respectively. Web site 118 includes a processing engine 112, which selectively inserts formatting commands into textual information 106 to be displayed on a web page.

During operation, the system illustrated in FIG. 1 operates generally as follows. User 101 inputs text 106 into browser 104, and submits text 106 to web site 110 within server 108. Processing engine 112 within web site 110 selectively inserts formatting commands into text 106 to produce HTML text 116. This enables HTML text 116 to be displayed to user 119 through browser 112 located on client 120.

Note that the present invention can generally be applied to any type of computer system, and is not limited to a networked computer system as is illustrated in FIG. 1. For example, the present invention can be used with a stand-alone computer system.

Also note that the present invention is not limited the systems that include web browsers and/or web sites. The present invention can generally be used with any system that has the ability to render formatting commands, such as HTML commands.

### Process of Selectively Inserting Formatting Commands

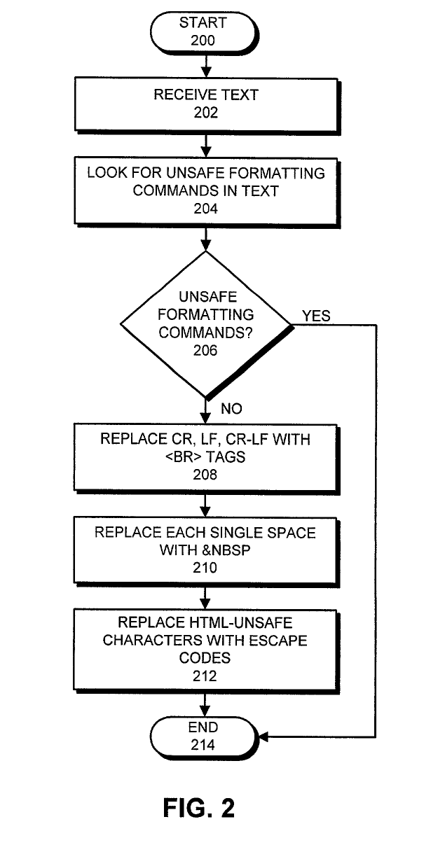

FIG. 2 is a flow chart illustrating the process of selectively inserting formatting commands into textual information in accordance with an embodiment of the present invention. The system first receives text 106 from user 101 to be inserted into a web page (step 202). In the embodiment illustrated in FIG. 1, text 106 is entered into browser 104 and is then submitted to web site 110, where it is directed to processing engine 112.

Next, the system looks for formatting commands in text 106 that are “unsafe.” These unsafe commands may indicate that an advanced user has inserted formatting commands into text 106. For example, the presence of a line break <br> tag, a paragraph <p> tag or table-related command (table,td,tr,th) in the text may indicate that an advanced user wants perform his own formatting. These unsafe commands may also indicate that there exist formatting commands within text 106 that will not work if additional formatting commands are added. For example, an image tag that spans multiple lines will not work if line break tags <br> are inserted within the image tag.

Note that “safe” commands can include commands that affect the appearance of textual information, but not the location of the textual information, such as bold (<b>,</b>), italic (<i>,</i>) and underline (<u>,<\u>) commands, as well as commands that insert a horizontal line (<hr>), and image tags that fit on a single line (<img>).

If unsafe commands are found, the system does nothing to text 106, and simply passes it straight through to become HTML text 116.

If no unsafe tags are found, the system replaces carriage return and line feed characters (CR, LF, CR-LF) with line break <br> tags (step 208). The system also replaces single spaces in the text with explicit space commands “&NBSP” (step 210). Note that if this were not done, the single spaces would be ignored when rendering the web page.

The system also replaces HTML unsafe character with corresponding escape codes (step 212). For example, a “<” character, which may be part of an HTML tag, is replaced with the corresponding escape code “&lt”. This is done because a novice user may accidentally include characters in text 106 that would be interpreted as an HTML command by browser 122. Other unsafe characters and corresponding escape codes include {“>”,“&gt”} and {“&”,“&amp”}.

Next, the system outputs HTML text 116, which can be stored in a file for eventual display on browser 122.

TABLE 1

sub containHTMLtags {
my($message) = @_;
my($result);
$message =˜ tr/A-Z/a-z/;
$message =˜ s/\<(b|i|u|hr|b\/|i\/|u\/)\>//g;
$message =˜ s/\<img.*?>//g;
if($message =˜ /<(\W[\hat{ }>]*)>/) {
$result = 1;
}
else {
$result = 0;
}
}

An example section of code (written in the PERL programming language), which determines if text contains safe commands appears in Table 1. This code first converts the text to lower case, and then strips out safe tags before testing for any remaining unsafe tags.

### EXAMPLES

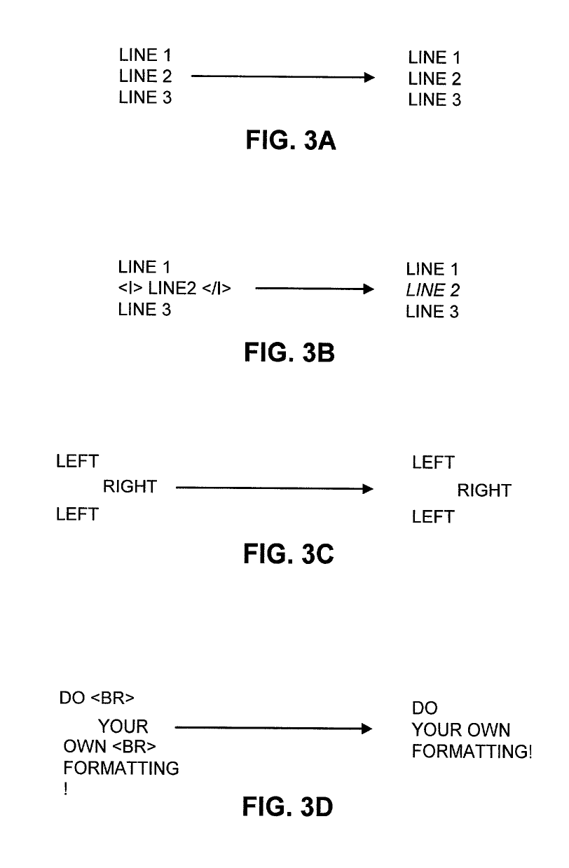

FIG. 3A illustrates an example of how specific textual information appears on a display in accordance with an embodiment of the present invention. In this example, line break tags are inserted in place of newlines characters in text 106 so that the resulting displayed text has line breaks. Otherwise, the resulting displayed text would all appear on the same line.

FIG. 3B illustrates another example of how specific textual information appears on a display in accordance with an embodiment of the present invention. In this example, line breaks are inserted into text 106 in place of newline characters in spite of the fact that “safe” italicizing commands surround line2.

FIG. 3C illustrates yet another example of how specific textual information appears on a display in accordance with an embodiment of the present invention. In this example, spaces (&NBSP) are inserted into text 106 in addition to the newline tags so that the label “right” is indented to the right in the display as it is in the text. Otherwise, the indentation would be removed in the resulting displayed text.

FIG. 3D illustrates an additional example of how specific textual information appears on a display in accordance with an embodiment of the present invention. In this example, the presence of the line break tags <br> causes the system not to insert formatting commands into text 106. Hence, in the displayed text, no line break appears between the words “YOUR” and “OWN”, and no line break appears between the word “FORMATTING” and the symbol “!”. Moreover, the word “YOUR” is not indented in the displayed text because the spaces in text 106 are ignored.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. For example the present invention is not limited to text formatting commands expressed in the HTML language. In general, the text formatting commands can be expressed in any language that allows formatting commands to be inserted into text.

Additionally, the above disclosure is not intended to limit the present invention. The scope of the present invention is defined by the appended claims.

What is claimed is:

1. A method for selectively inserting formatting commands into textual information to be displayed on a web page, comprising:
receiving the textual information from a user to be displayed on the web page;
looking for specific formatting commands in the textual information, which indicate that additional formatting commands should not be inserted into the textual information;
if none of the specific formatting commands are found in the textual information, inserting additional formatting commands into the textual information so the textual information is displayed on the web page in substantially the same format as it was entered by the user.

2. The method of claim 1, wherein the specific formatting commands include commands that alter a location of the textual information within the web page.

3. The method of claim 1, wherein the specific formatting commands include commands that will not work if additional formatting commands are added to the textual information.

4. The method of claim 1, wherein the specific formatting commands adhere to the Hypertext Markup Language (HTML) standard.

5. The method of claim 4, further comprising replacing HTML-unsafe characters with HTML-safe escape codes to avoid problems in displaying the textual information.

6. The method of claim 4, wherein the specific formatting commands do not include commands that make bold text, italicize text, underline text, and add a horizontal line.

7. The method of claim 4, wherein the specific formatting commands include: line break, paragraph and table-related commands.

8. The method of claim 4, wherein inserting additional formatting commands involves:
replacing newline characters with break tags; and
replacing single spaces with space commands.

9. A computer-readable storage medium storing instructions that when executed by a computer cause the computer to perform a method for selectively inserting formatting commands into textual information to be displayed on a web page, the method comprising:
receiving the textual information from a user to be displayed on the web page;
looking for specific formatting commands in the textual information, which indicate that additional formatting commands should not be inserted into the textual information;
if none of the specific formatting commands are found in the textual information, inserting additional formatting commands into the textual information so the textual information is displayed on the web page in substantially the same format as it was entered by the user.

10. The computer-readable storage medium of claim 9, wherein the specific formatting commands include commands that alter a location of the textual information within the web page.

11. The computer-readable storage medium of claim 9, wherein the specific formatting commands include commands that will not work if additional formatting commands are added to the textual information.

12. The computer-readable storage medium of claim 9, wherein the specific formatting commands adhere to the Hypertext Markup Language (HTML) standard.

13. The computer-readable storage medium of claim 12, wherein the method further comprises replacing HTML-unsafe characters with HTML-safe escape codes to avoid problems in displaying the textual information.

14. The computer-readable storage medium of claim 12, wherein the specific formatting commands do not include commands that make bold text, italicize text, underline text, and add a horizontal line.

15. The computer-readable storage medium of claim 12, wherein the specific formatting commands include: line break, paragraph and table-related commands.

16. The computer-readable storage medium of claim 12, wherein inserting additional formatting commands involves:
replacing newline characters with break tags; and
replacing single spaces with space commands.

17. An apparatus that selectively inserts formatting commands into textual information to be displayed on a web page, comprising:
a receiving mechanism that is configured to receive the textual information from a user to be displayed on the web page;
an examination mechanism that is configured to look for specific formatting commands in the textual information, which indicate that additional formatting commands should not be inserted into the textual information;
an insertion mechanism, wherein if none of the specific formatting commands are found in the textual information, the insertion mechanism is configured to insert additional formatting commands into the textual information so the textual information is displayed on the web page in substantially the same format as it was entered by the user.

18. The apparatus of claim 17, wherein the specific formatting commands include commands that alter a location of the textual information within the web page.

19. The apparatus of claim 17, wherein the specific formatting commands include commands that will not work if additional formatting commands are added to the textual information.

20. The apparatus of claim 17, wherein the specific formatting commands adhere to the Hypertext Markup Language (HTML) standard.

21. The apparatus of claim 20, further comprising a replacement mechanism that is configured to replace HTML-unsafe characters with HTML-safe escape codes to avoid problems in displaying the textual information.

22. The apparatus of claim 20, wherein the specific formatting commands do not include commands that make bold text, italicize text, underline text, and add a horizontal line.

23. The apparatus of claim 20, wherein the specific formatting commands include: line break, paragraph and table-related commands.

24. The apparatus of claim 20, the insertion mechanism is configured to:
replace newline characters with break tags; and to
replace single spaces with space commands.
